(19) United States
(12) Patent Application Publication
(10) Pub. No.: US 2010/0118328 A1
(43) Pub. Date: May 13, 2010

(54) PRINT MANAGEMENT METHOD, COMPUTER READABLE RECORDING MEDIUM STORED WITH PRINT MANAGEMENT PROGRAM, AND PRINT MANAGEMENT APPARATUS

(75) Inventor: Tamotsu SAKURABA, Chiyoda-ku (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/611,484

(22) Filed: Nov. 3, 2009

(30) Foreign Application Priority Data
Nov. 7, 2008 (JP) 2008-286829

(51) Int. Cl. G06K 15/00; G06F 3/12

(52) U.S. Cl. 358/1.14; 358/1.15

(57) ABSTRACT

The print management method according to the present invention comprises: (a) recognizing an occurrence of a fault in a printing apparatus which has been designated to print a document; (b) making a judgment as to whether or not a color page is included in the document when the occurrence of the fault in the printing apparatus is recognized; (c) determining a start page for a substitute printing apparatus to start printing the document, which serves as a substitute for the printing apparatus, based on the judgment result of step (b); and (d) designating the substitute printing apparatus to print the document from the start page determined in step (c).

### CROSS-REFERENCE TO RELATED APPLICATION

This application is based on Japanese Patent Application No. 2008-286829 filed on Nov. 7, 2008, the contents of which are incorporated herein by reference.

### BACKGROUND

1. Technical Field

The present invention relates to a print management method, a computer readable recording medium stored with a print management program, and a print management apparatus. The present invention particularly relates to a print management method, a computer readable recording medium stored with a print management program, and a print management apparatus which are used primarily in a substitute printing process.

2. Description of Related Art

In the field of production printing, when a fault occurs in a printer which has been designated to print a document and the printing process is interrupted, substitute printing is implemented in order to continue printing by another printer connected to the network.

As to the technology related to substitute printing, an image output system has been proposed as disclosed in the Unexamined Japanese Patent Publication No. 2000-351241 for the purpose of maintaining a better appearance of a printed output. The image output system disclosed in the Unexamined Japanese Patent Publication No. 2000-351241 is for converting the image data in such a way that the color reproduction of a color image output from a substitute printer matches with the color reproduction of a color image output from the first printer in designating substitution printing to the substitute printer. With such a constitution, it is possible to suppress subtle color change in images which may occur at a certain page in the middle of a printed output due to the difference of the output characteristics between the first printer and the substitute printer.

However, it is impossible to suppress completely subtle color change in images which may occur at a certain page in the middle of a printed output even with the best effort of converting the image data in order to match the color reproduction of the first printer and the color reproduction of the substitute printer. Therefore it is desirable to be able to infallibly prevent subtle color change in images which may occur at a certain page in the middle of a printed output.

### SUMMARY

The present invention is intended to solve the abovementioned problem. The objective of the present invention is to provide a print management method, a computer readable recording medium stored with a print management program, and a print management apparatus, capable of preventing subtle color change in images which may occur at a certain page in the middle of a printed output due to substitute printing.

To achieve at least one of the abovementioned objects, the print management method reflecting one aspect of the present invention comprises: (a) recognizing an occurrence of a fault in a printing apparatus which has been designated to print a document; (b) making a judgment as to whether or not a color page is included in the document when the occurrence of the fault in the printing apparatus is recognized; (c) determining a start page for a substitute printing apparatus to start printing the document, which serves as a substitute for the printing apparatus, based on the judgment result of step (b); and (d) designating the substitute printing apparatus to print the document from the start page determined in step (c).

It is preferable in the abovementioned print management method that a succeeding page to the one printed by the printing apparatus immediately before the occurrence of the fault, is determined as the start page in step (c), when it is judged that no color page is included in the document in step (b); and a top page of the document is determined as the start page in step (c), when it is judged that a color page is included in the document in step (b).

It is preferable that the abovementioned print management method further comprises: (b1) making a judgment as to whether or not a color page is included in the pages yet to be printed by the printing apparatus, when it is judged that a color page is included in the document in step (b), wherein the top page is determined as the start page in step (c), when it is judged that a color page is included in the pages yet to be printed; and the succeeding page is determined as the start page in step (c), when it is judged that no color page is included in the pages yet to be printed.

It is preferable that the abovementioned print management method further comprises: (e) calculating the number of yet-to-be-printed copies of the document by subtracting the number of copies of the document which has been printed by the printing apparatus from the number of copies of the document which has been assigned to the printing apparatus for printing; wherein the substitute printing apparatus is designated to print the number of yet-to-be-printed copies of the document calculated in step (e), in addition to printing the document from the start page, in step (d).

It is preferable that the abovementioned print management method further comprises: (f) receiving user-specified setting concerning whether or not the substitute printing apparatus should execute printing of the same number of copies of the document as the number of copies of the document which has been assigned to the printing apparatus for printing, when a color page is included in the document, wherein the top page of the document is determined as the start page in step (c), and the substitute printing apparatus is designated to print the same number of copies of the document, in addition to printing the document from the start page in step (d), when the user-specified setting states that the substitute printing apparatus should execute printing of the same number of copies of the document.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a printing system according to an embodiment of the present invention.

FIG. 2 is a block diagram showing the constitution of the first printer shown in FIG. 1.

FIG. 3 is a block diagram showing the constitution of the client terminal shown in FIG. 1.

FIG. 4 is a block diagram showing the contents of the hard disk shown in FIG. 3.

FIG. 5 is a block diagram showing the constitution of the printer controller shown in FIG. 1.

FIG. 6 is a block diagram showing the contents of the ROM shown in FIG. 5.

FIG. 7 is a sequence chart for describing the outline of the operation of the printing system shown in FIG. 1.

FIG. 8 is a flowchart for describing the print management process by the printer controller shown in FIG. 1.

FIG. 9 is a flowchart for describing the detail of the error recovery process shown in step S110 of FIG. 8.

FIG. 10 is a diagram showing an example of the error recovery setting screen.

FIG. 11 is a flowchart for describing the process of the printer controller in the general substitute printing.

### DETAILED DESCRIPTION

The embodiment of this invention will be described below with reference to the accompanying drawings.

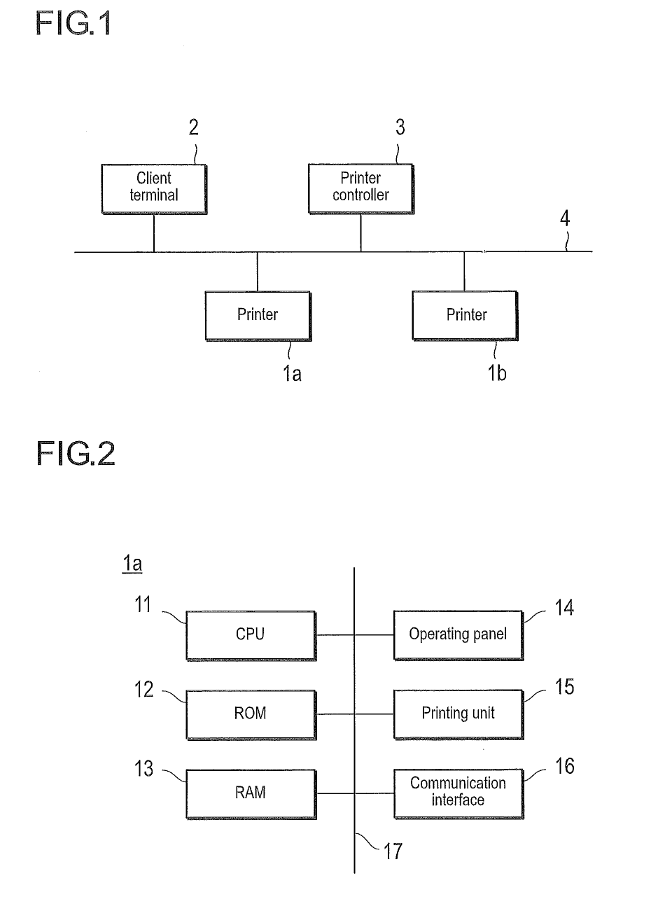

FIG. 1 is a block diagram showing the overall constitution of a printing system according to an embodiment of the present invention.

As shown in FIG. 1, the printing system according to the present embodiment has first and second printers 1a and 1b, client terminal 2, and a printer controller 3. The first and second printers 1a and 1b, a client terminal 2, and the printer controller 3 are interconnected via a network 4 so that they can communicate with each other.

The network 4 consists of various networks such as a LAN connecting computers and network equipment according to standards such as Ethernet, Token Ring, and FDDI, or a WAN that consists of several LANs connected by a dedicated line. The types and the number of equipment to be connected to the network 4 are not limited to those shown in FIG. 1.

FIG. 2 is a block diagram showing the constitution of the first printer shown in FIG. 1. The first printer 1a as a printing apparatus includes a CPU 11, a ROM 12, a RAM 13, an operating panel 14, a printing unit 15, and a communication interface 16, all of which are interconnected by a bus 17 for exchanging signals.

The CPU 11 controls various parts indicated above and executes various arithmetic processes according to a program. The ROM 12 stores various programs and data. The RAM 13 stores programs and data temporarily as a working area.

The operating panel 14 is equipped with a touch panel, a ten-key pad, a start button, a stop button and others to be used for displaying various data and entering various instructions. The printing unit 15 prints images based on various data on a recording medium such as paper using a known image forming process such as an electronic photography type process.

The communication interface 16 is an interface for communications with other devices such as the printer controller 3 via the network 4, for which various local connection interfaces, e.g., network interfaces such as Ethernet, Token Ring, and FDDI standards, serial interfaces such as USB and IEEE 1394, parallel interfaces such as SCSI, IEEE 1284, and wireless communication interfaces such as Bluetooth (registered trademark), IEEE 802.11, HomeRF, IrDA, as well as telephone circuit interfaces for connection to telephone circuits can be used.

The constitution of the second printer 1b, which serves as a substitute printing apparatus, is identical to that of the first printer 1a, so that its description is omitted here.

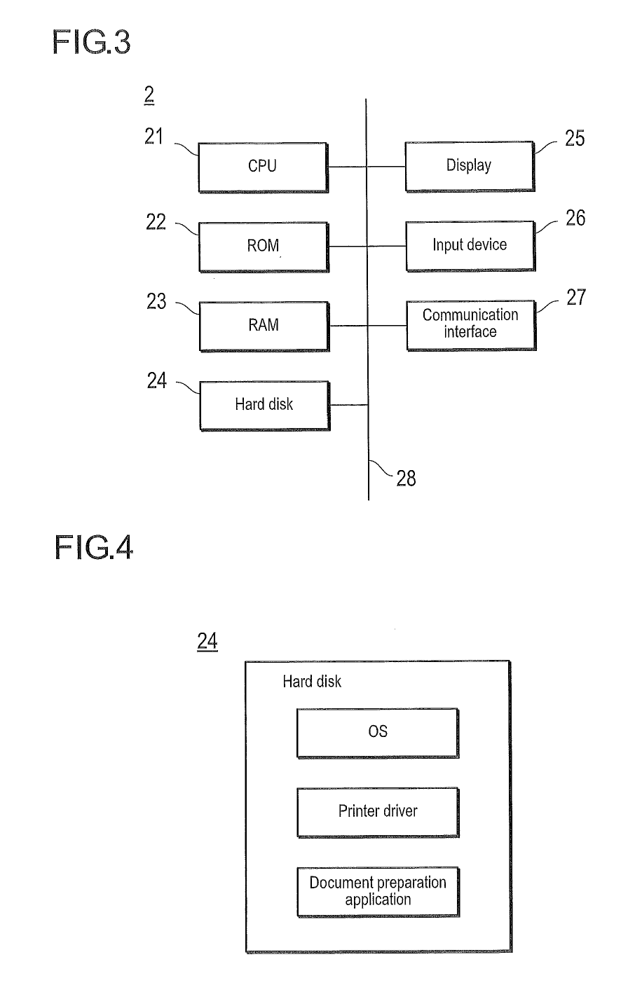

FIG. 3 is a block diagram showing the constitution of the client terminal shown in FIG. 1. The client terminal 2 includes a CPU 21, a ROM 22, a RAM 23, a hard disk 24, a display 25, an input device 26, and a communication interface 27, all of which are interconnected by a bus 28 for exchanging signals. The descriptions of those parts of the client terminal 2 that have the same functions as those of the corresponding parts of the first printer 1a will be omitted here to avoid being duplicative.

The hard disk 24 stores various programs including an operating system (hereinafter called “OS”) and data. The display 25 is typically a CRT or a LCD and displays various kinds of information. The input device 26 consists of pointing devices such as a mouse, a keyboard, and others, and is used for making various kinds of inputs.

FIG. 4 is a block diagram showing the contents of the hard disk of the client terminal shown in FIG. 3.

As shown in FIG. 4, the OS, a document preparation application program for preparing document files, and a printer driver for preparing print data by converting the documents files into PDL data described in the Page Description Language (PDL) that the printer controller 3 can understand are installed on the hard disk 24 of the client terminal 2.

FIG. 5 is a block diagram showing the constitution of the printer controller shown in FIG. 1. The printer controller 3 as a print management apparatus includes a CPU 31, a ROM 32, a RAM 33, a hard disk 34, a display 35, an input device 36, and a communication interface 37, all of which are interconnected by a bus 38 for exchanging signals. Various parts of the printer controller 3 are similar to those corresponding parts of the client terminal 2 so that their descriptions are omitted here.

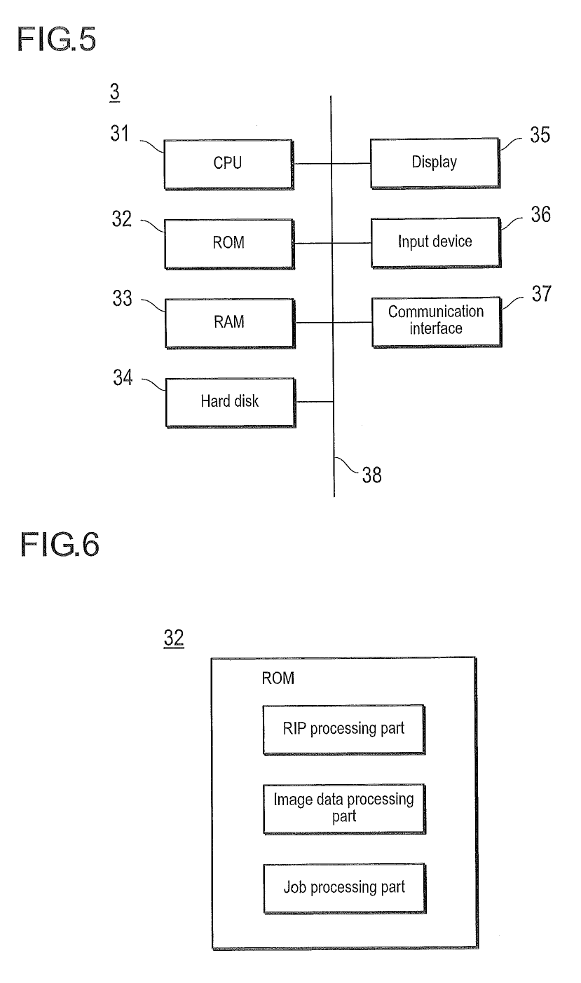

FIG. 6 is a block diagram showing the contents of the ROM of the printer controller shown in FIG. 5.

As shown in FIG. 6, the ROM 32 of the printer controller 3 has areas for storing the programs that correspond to a RIP processing part, an image data processing part, and a job processing part. The RIP processing part executes the RIP process based on the print data received from the client terminal 2. In other words, the RIP processing part converts the PDL data included in the print data into the image data of the bitmap format (hereinafter called “bitmap image data”) which the first and second printers 1a and 1b use for printing. The image data processing part analyzes the method for processing the PDL data. The job processing part designates the transmission and output methods of the bitmap image data to the first and second printers 1a and 1b. The functions of the RIP processing part, the image data processing part, and the job processing part are implemented as the CPU 31 executes their respective programs.

The first and second printers 1a and 1b, the client terminal 2, and the printer controller 3 can each include constituents other than those described above, or may lack a portion of the abovementioned constituents.

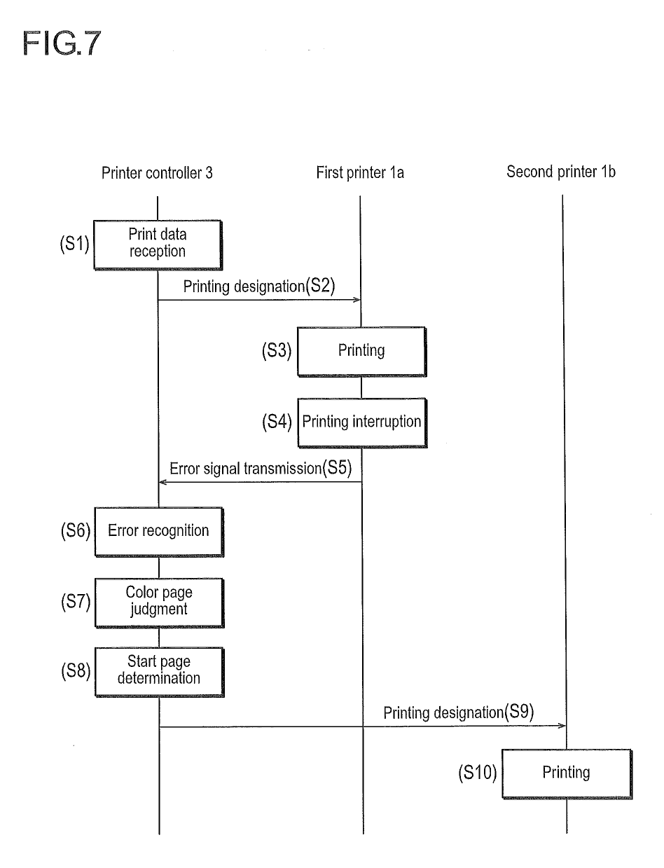

Next, the outline of the operation of the printing system of the present embodiment will be described below with reference to the sequence chart shown in FIG. 7.

FIG. 7 shows a case where the printer controller 3 recognizes that an error has occurred in the first printer 1a after designating the first printer 1a to print a document consisting of a plurality of pages, and designates the second printer 1b to print the document as a substitute. The errors which can occur in the first printer 1a include printing process problems such as printing paper jam, printing paper shortage, and power failures, all of which cause interruptions of document printing by the first printer 1a.

First, the printer controller 3 receives the print data from the client terminal 2 (S1), and designates the first printer 1a to print the document (S2).

The first printer 1a starts the printing of the document as it receives the instruction to print the document from the printer controller 3 (S3).

When an error occurs in the first printer 1a, the document printing by the first printer 1a is interrupted (S4).

The first printer 1a whose document printing is interrupted transmits the error signal to the printer controller 3 notifying that an error has occurred (S5). The error signal transmitted to the printer controller 3 may include information showing the specific information on the error (e.g., paper jam).

The printer controller 3 recognizes the fact that an error occurred in the first printer 1a as it receives an error signal from the first printer 1a (S6).

Next, the printer controller 3 makes a judgment on whether or not a color page is included in the document which has been designated to be printed by the first printer 1a (S7), and determines the start page of the document to be printed by the second printer 1b as the substitute printer (S8). More specifically, if no color page is included in the document, the page next to the page that was printed last by the first printer 1a (hereinafter called “succeeding page”) is determined as the start page of the document to be printed by the second printer 1b as the substitute printer. On the other hand, if a color page is included in the document, the top page of the document is determined as the start page of the document to be printed by the second printer 1b as the substitute printer.

The printer controller 3 designates the second printer 1b as the substitute printer to print the document from the start page determined as above (S9).

The second printer 1b starts substitute printing from the start page designated by the printer controller 3 as it receives the instruction to print the document from the printer controller 3 (S10). In other words, the second printer 1b prints the document from the succeeding page if no color page is included in the document, and the second printer 1b prints the document from the top page if a color page is included in the document.

If a color page is included in the document and the second printer 1b prints it from the succeeding page, subtle color change in images may occur at a certain page in the middle of a printed output due to the difference of the output characteristics between the first printer 1a and the second printer 1b. However, if the second printer 1b prints the document from the top page, subtle color change in images occurring at certain a page in the middle of the printed output can be avoided.

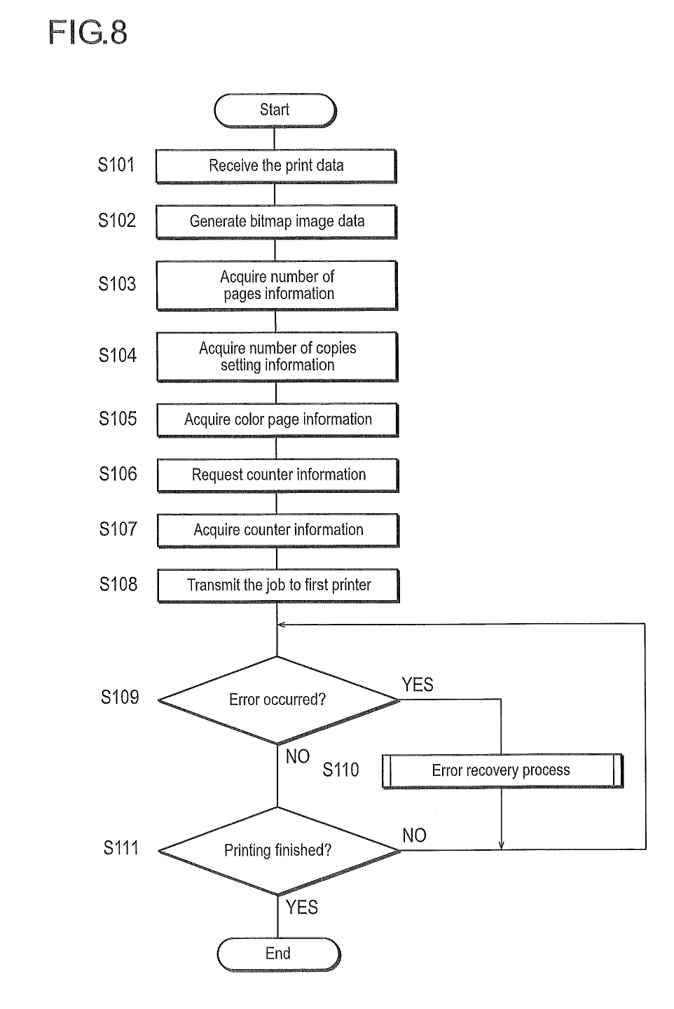

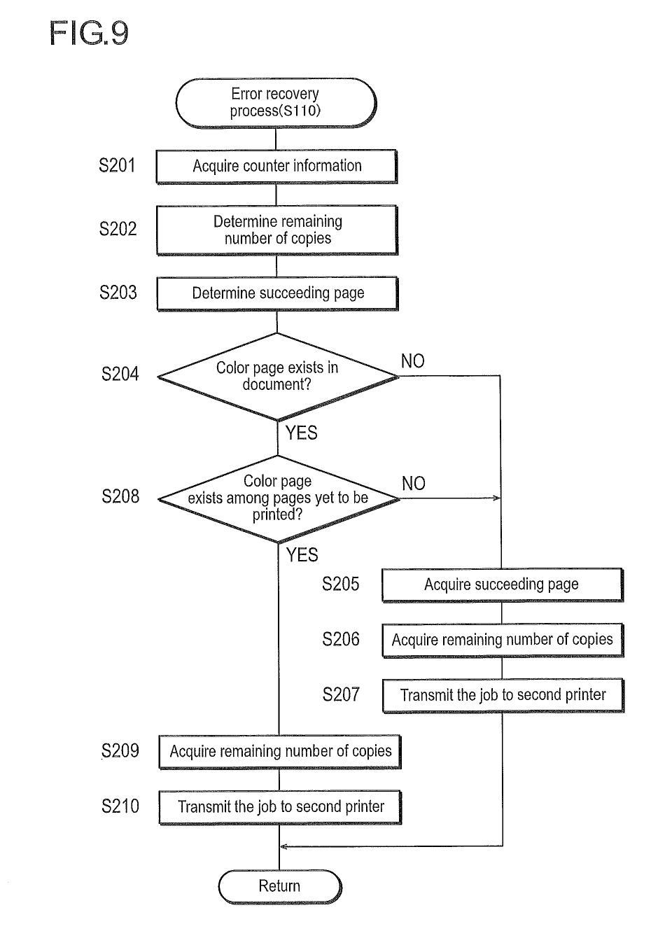

Next, the operation of the printer controller according to the present embodiment will be described below in detail referring to FIG. 8 and FIG. 9.

FIG. 8 is a flowchart for describing the print management process by the printer controller shown in FIG. 1. The algorithm shown in the flowchart of FIG. 8 is stored as a program in the ROM 32 of the printer controller 3 and executed by the CPU 31.

As shown in FIG. 8, in the print management process of the present embodiment, first, the print data of the document designated to be printed by the user is received (step S101). In the present embodiment, the print data of the document transmitted from the client terminal 2 in accordance with the document printing instruction by the user is received. The print data consists of PDL data and print setting data. The PDL data is generated by converting the document file by the printer driver of the client terminal 2, while the print setting data includes the information on the number of copies of the document set up by the user.

Next, the bitmap image data of the document is generated (step S102). In the present embodiment, the PDL data included in the print data received in the process shown in step S101 is converted into bitmap image data by the RIP process.

Next, the information on the number of pages of the document and the setting information on the number of copies of the document is acquired (step S103, 5104). In the present embodiment, the number of pages of the document and the number of copies of the document designated by the user are acquired from the PDL data and the print setting data which constitute the print data respectively.

Next, the color page information is acquired (step S105). In the present embodiment, the page number of the color page included in the document is acquired based on the color information (C, Y, M) included in the bitmap image data generated by the process shown in step S102.

Next, a request signal for requesting the counter information is transmitted to the first printer 1a (step S106), and the counter information of the first printer 1a is acquired (step S107). In the present embodiment, the counter information of the first printer 1a is grasped in order to determine the number of pages and the number of copies of the document printed by the first printer 1a.

Next, the job is transmitted to the first printer 1a (step S108). In the present embodiment, the job which includes the information on the number of copies to be printed and the document information that consist of the bitmap image data generated in the process shown in step S102 is transmitted to the first printer 1a. As a result, the first printer 1a starts printing the document.

Next, a judgment is made as to whether or not an error has occurred in the first printer 1a (step S109). In the present embodiment, it is recognized that an error has occurred in the first printer 1a as the error is detected by the first printer 1a and the printer controller 3 receives an error signal transmitted by the first printer 1a. Or, if the counter information (status information) of the first printer 1a acquired at a specified time interval from the first printer 1a does not change after a certain period of time, it is recognized that an error has occurred in the first printer 1a as the printer controller 3 detects an error such as a power failure of the first printer 1a.

If an error occurrence in the first printer 1a is recognized (step S109: Yes), an error recovery process is executed designating the second printer 1b to perform substitute printing of the document (step S110). In the present embodiment, the start page for the second printer 1b, which serves as a substitute for the first printer 1a, to start printing the document is determined, and the second printer 1b is designated to print the document from the determined start page. The detail of the error recovery process shown in step S110 will be described later.

On the other hand, if no error occurs in the first printer 1a (step S109: No), a judgment is made as to whether or not the document printing is completed (step S111). In the present embodiment, it is judged whether the number of copies designated by the user has been printed or not by making a judgment whether or not the value obtained by subtracting the counter value obtained in the process shown in step S107 from the counter value obtained from the first printer 1a matches with the total number of printed pages calculated as a product of the total number of pages of the document and the number of copies to be printed.

If it is judged that the document printing is not completed (step S111: No), the process of steps S109 and thereafter is repeated until the document printing of the abovementioned number of copies to be printed is completed. On the other hand, if it is judged that the document printing is completed (step S111: Yes), the process is terminated.

As described in the above, according to the flowchart shown in FIG. 8, the second printer 1b is designated to print the document as a substitute for the first printer 1a, if an error occurrence in the first printer 1a is recognized after the first printer 1a is designated to print the document. In such an occasion, the start page of the document from which the second printer 1b prints it is determined, and the second printer 1b is designated to print the document from the determined start page.

FIG. 9 is a flowchart for describing the detail of the error recovery process shown in step S110 of FIG. 8. The algorithm shown in the flowchart of FIG. 9 is stored as a program in the ROM 32 of the printer controller 3 and executed by the CPU 31.

As shown in FIG. 9, in the error recovery process of the present embodiment, first, the counter information of the first printer 1a is acquired (step S201). In the present embodiment, the counter information of the first printer 1a, in which the printing is interrupted due to the error occurrence, is acquired.

Next, the remaining number of copies to be printed is determined (step S202). In the present embodiment, first, the number of copies of the document which has been printed by the first printer 1a is calculated based on the total number of pages of the document and the counter information of the first printer 1a acquired in the process shown in step S201. The remaining number of copies to be printed is acquired by subtracting the number of copies thus calculated from the number of copies of the document set up by the user.

Next, the page number of the succeeding page is determined (step S203). In the present embodiment, the page number of the succeeding page that follows the page that has been printed by the first printer 1a just before the error occurred is obtained, based on the total number of pages of the document and the counter information acquired in the process shown in step S201. For example, assuming an error occurred just after the page 8 of the document is printed by the first printer 1a, “page 9” is acquired as the page number of the succeeding page.

Next, a judgment is made as to whether or not any color page is included in the document (step 204). In the present embodiment, a judgment is made as to whether or not any color page is included in the document based on the color page information acquired in the process shown in step S105 of FIG. 8.

If it is judged that no color page is included in the document (step S204: No), the page number of the succeeding page is acquired as the start page of the document to be printed by the second printer 1b (step S205). In the present embodiment, if the document is a monochromatic document, it is allowed to print the document from the succeeding page as subtle color change in images at a certain page in the middle of the printed output can be hardly recognized. Therefore, the page number of the succeeding page determined in the process shown in step S203 is acquired as that of the start page.

Next, the remaining number of copies to be printed is acquired as the number of copies of the document to be printed by the second printer 1b (step S206). In the present embodiment, the remaining number of copies determined in the process shown in step S202 is acquired as the number of copies of the document to be printed by the second printer 1b.

Next, the job is transmitted to the second printer 1b (step S207). In the present embodiment, the job designating the printing of the remaining number of copies acquired in the process in step S206 is transmitted to the second printer 1b with the succeeding page acquired in the process shown in step S205 designated as the start page. As a result, the second printer 1b prints the remaining number of copies of the document from the page succeeding the last page printed by the first printer 1a. For example, if we assume that an error occurs to the first printer 1a immediately after the eighth page of the 16th copy has been printed for the document for which 30 copies of printing is set up by the user, the second printer 1b prints the first copy starting at the ninth page and all the pages of the remaining 14 copies.

On the other hand, if a color page is included in the document (step S204: Yes), a judgment is made as to whether or not any color page is included in the pages not yet printed by the first printer 1a (step S208). For example, if an error occurs to the first printer 1a immediately after the eighth page of the document consisting of 20 pages, for which one copy of printing is set up by the user, has been printed, a judgment is made as to whether or not any color page is included between the ninth page through 20th page of the document.

If it is judged that no color page is included in the pages yet to be printed by the first printer 1a (step S208: No), it moves on to the process of step S205 based on the notion that all the pages to be printed by the second printer 1b are monochromatic pages. As a result, the second printer 1b prints the document from the page succeeding the last page printed by the first printer 1a.

On the other hand, if it is judged that a color page is included in the pages yet to be printed by the first printer 1a (step S208: Yes), the remaining number of copies to be printed is acquired as the number of copies to be printed by the second printer 1b (step S209). In the present embodiment, the top page of the document is determined as the start page for printing, as subtle color change in images is recognizable at a certain page in the middle of the printed output if a color page is included in the pages yet to be printed. Moreover, the remaining number of copies determined in the process shown in step S202 is acquired as the number of copies of the document to be printed by the second printer 1b.

Next, the job is transmitted to the second printer 1b (step S210). In the present embodiment, the job that designates the printing of the remaining number of copies acquired in the process shown in step S209 is transmitted to the second printer 1b. As a result, the second printer 1b prints the remaining number of copies from the top page. For example, if we assume that an error occurs to the first printer 1a immediately after the eighth page of the 16th copy has been printed for the document for which 30 copies of printing is set up by the user, the second printer 1b prints all the pages of the remaining 15 copies. By substitute-printing the document from the top page, any subtle color change in images occurring at a certain page in the middle of the printed output due to switch from the first printer 1a to the second printer 1b can be avoided.

As can be seen from the above, a judgment is made first as to whether or not any color page is included in the document in the process according to the flowchart shown in FIG. 9. If it is judged that a color page is not included in the document, the second printer 1b is designated to print the document from the succeeding page. On the other hand, if it is judged that a color page is included in the document, a further judgment is made as to whether or not any color page is included in the pages yet to be printed. If it is judged that a color page is not included in the pages yet to be printed, the second printer 1b is designated to print the document from the succeeding page. On the other hand, if it is judged that a color page is included in the pages yet to be printed, the second printer 1b is designated to print the document from the top page. By printing the document from the top page, any subtle color change in images occurring at a certain page in the middle of the printed output can be avoided. Consequently, the print management process according to the present embodiment maintains good appearances of the images of the printed output.

As described above, in the print management process according to the present embodiment, the second printer 1b is designated to print each of the remaining copies within the printed output from the top page of the document in order to prevent subtle color change in images which may occur at a certain page in the middle of one copy. However, if it is desired to prevent even subtle color change in images between the copies in case of printing a plurality of copies, the second printer 1b can be designated to print the same number of copies of the document as the number of copies originally designated to be printed by the first printer 1a.

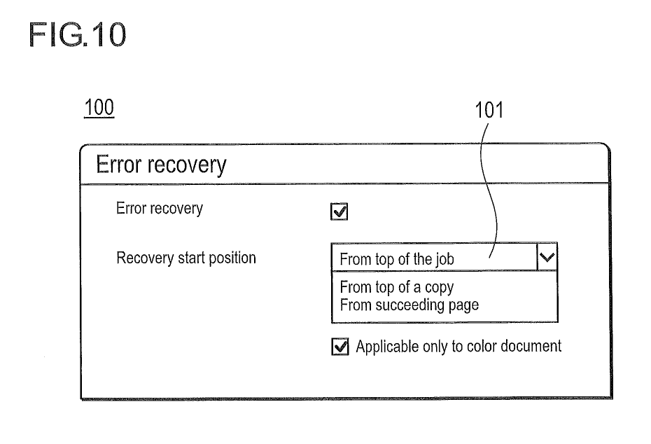

FIG. 10 is a diagram showing an example of the error recovery setting screen. An error recovery setting screen 100 is provided for the user to set up the start page and the number of copies to be printed by the second printer 1b as a substituted printer. The error recovery setting screen 100 is displayed on the display 35 of the printer controller 3 for the manager to set up the printer controller 3.

As shown in FIG. 10, the error recovery setting screen 100 has a recovery start position setting part 101 for the user to set up the start page and the number of copies of the document to be printed by the second printer 1b. The recovery start position setting part 101 allows the user to choose between three settings, i.e., “from the top of the job,” “from the top of a copy,” and “from the succeeding page.”

If “from the top of the job” is set up by the user, the second printer 1b is designated to print the same number of copies as the number of copies set up originally by the user when an error occurrence in the first printer 1a is recognized. More specifically, when it is judged that a color page is included in the document, the printer controller 3 transmits the same job as the job transmitted to the first printer 1a to the second printer 1b. As a result, the second printer 1b prints the same number of copies as the number of copies the first printer 1a is designated to print. For example, if we assume that an error occurs to the first printer 1a immediately after the eighth page of the 16th copy has been printed for the document for which 30 copies of printing is set up by the user, the second printer 1b prints all 30 copies of the document from the start. Thus, any subtle color change in images can be prevented from occurring between the copies.

Also, if “from the top of a copy” is set up by the user, the second printer 1b is designated to print the remaining number of copies from the top page of the document when an error occurrence in the first printer 1a is recognized, as described above. As a result, the second printer 1b prints the remaining number of copies from the top page. Therefore, subtle color change in images is prevented from occurring at a certain page in the middle of one copy.

On the other hand, if “from the succeeding page” is set up by the user, the second printer 1b is designated to print the document from the page succeeding the last page printed by the first printer 1a when an error occurrence in the first printer 1a is recognized. As a result, the second printer 1b prints the remaining number of copies from the succeeding page.

Lastly, the process of a printer controller in a conventional substitute printing will be described below as a comparison.

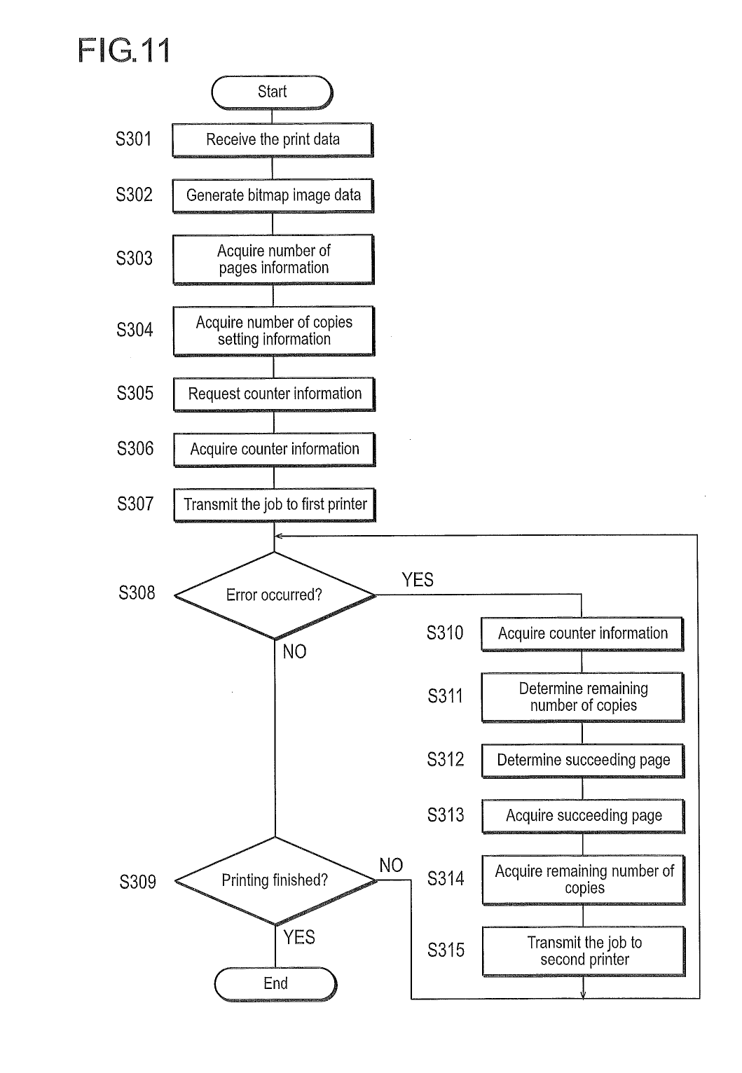

FIG. 11 is a flowchart for describing the process of the printer controller in the general substitute printing. The process shown in the flowchart of FIG. 11 corresponds to a case where the user designates “from the succeeding page” in the recovery start position setting part 101 of the error recovery setting screen 100 shown in FIG. 10.

As shown in FIG. 11, in the general substitute printing process, the print data is first received and the bitmap image data of the document is generated (steps S301, S302). Next, the information on the number of pages of the document and the setting information on the number of copies of the document is acquired (step S303, S304).

Next, a request signal for requesting the counter information is transmitted to the first printer 1a, and the counter information of the first printer 1a is acquired (steps S305, S306). Next, the job is transmitted to the first printer 1a (step S307).

Next, a judgment is made as to whether or not an error has occurred in the first printer 1a (step S308). If no error is occurring in the first printer 1a (step S308: No), a judgment is made as to whether or not the document printing is completed (step S309), and the process of steps S308 and thereafter is repeated until the document printing is completed. On the other hand, if it is recognized that an error has occurred in the first printer 1a (step S308: Yes), the counter information of the first printer 1a is first acquired (step S310).

Next, the remaining number of copies to be printed and the succeeding page is determined respectively (steps S311, S312). Thus determined remaining number of copies to be printed and succeeding page are acquired respectively (steps S313, S314).

Next, the job designating the document printing for the remaining number of copies starting at the succeeding page is transmitted to the second printer 1b (step S315). As a result, the second printer 1b prints the remaining number of copies of the document from the page succeeding the last page printed by the first printer 1a.

As described above, according to the process of the flowchart shown in FIG. 11, the document printing starting at the succeeding page is designated to the second printer 1b in case when an error occurs in the first printer 1a and the original printing is interrupted. In this case, subtle color change in images may occur at a certain page in the middle of the printed output due to the difference in the output characteristics between the first printer 1a and the second printer 1b.

In the meanwhile, according to the present embodiment, it is possible to change the document printing start page for the second printer 1b depending on whether or not a color page is included in the document. In other words, it is possible to designate the second printer 1b to start its printing from the top page of the document, if a color page is included in the document. Therefore, it is possible to prevent subtle color changes in images which may occur at a certain page in the middle of a printed output due to the substitute printing.

The invention is not limited to the embodiment described above, but also can be changed in various ways within the scope of the claims.

For example, if it is judged that a color page is included in the document, printing from the top page of the document is designated to the substitute printer in the embodiment described above. However, the start page of the substitute printing does not have to be limited to the top page of the document, but rather the substitute printer can be designated to start printing at the top page of a chapter if the document consists of a plurality of chapters.

Also, in the embodiment described above, a process of managing the substitute printing is executed by the printer controller that executes the RIP process. However, the substitute print management apparatus does not have to be limited to the printer controller, but rather a client terminal or other information processing apparatuses can be used for managing the substituted printing. The error recovery setting screen described above is built into the printer driver and displayed on the display of the client terminal, and the recovery printing start position can be set up by the user at the client terminal. Alternatively, settings concerning the error recovery can be set up by various applications and Web tools.

It is also possible to use, in place of a printer, a printing apparatus such as a facsimile machine, a copying machine, or an MFP (multi-function peripheral) that has a combination of their functions.

Although it is constituted in the embodiment described above to acquire the page number of a color page included in the document based on the color information (C, Y, M) included in the bitmap image data acquired by the RIP process, it is also possible to acquire the page number of the color page by making a judgment as to whether it is a color page or not from commands or image files included in the PDL data as an alternative. More specifically, as a substitute for the color page judgment described above, it is also possible to make a judgment as to whether the particular page is a color page or not from the color designation commands of character data included in the PDL data, or to estimate that the particular page is a color page if the particular page includes image files to be drawn as such a page is likely to include color images.

The units and method of conducting various processes in the print management apparatus according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is ordinarily transferred to and stored in a memory unit such as a hard disk. Said program can also be provided as independent application software or can be built into the software of the information processing apparatus as a part of its function.

What is claimed is:

1. A print management method, comprising:
(a) recognizing an occurrence of a fault in a printing apparatus which has been designated to print a document;
(b) making a judgment as to whether or not a color page is included in said document when said occurrence of said fault in said printing apparatus is recognized;
(c) determining a start page for a substitute printing apparatus to start printing said document, which serves as a substitute for said printing apparatus, based on the judgment result of said step (b); and
(d) designating said substitute printing apparatus to print said document from said start page determined in said step (c).

2. The print management method as claimed in claim 1, wherein
a succeeding page to the one printed by said printing apparatus immediately before said occurrence of said fault, is determined as said start page in said step (c), when it is judged that no color page is included in said document in said step (b); and
a top page of said document is determined as said start page in said step (c), when it is judged that a color page is included in said document in said step (b).

3. The print management method as claimed in claim 2, further comprising:
(b1) making a judgment as to whether or not a color page is included in the pages yet to be printed by said printing apparatus, when it is judged that a color page is included in said document in said step (b), wherein
said top page is determined as said start page in said step (c), when it is judged that a color page is included in said pages yet to be printed; and
said succeeding page is determined as said start page in said step (c), when it is judged that no color page is included in said pages yet to be printed.

4. The print management method as claimed in claim 1, further comprising:
(e) calculating the number of yet-to-be-printed copies of said document by subtracting the number of copies of said document which has been printed by said printing apparatus from the number of copies of said document which has been assigned to said printing apparatus for printing; wherein
said substitute printing apparatus is designated to print said number of yet-to-be-printed copies of said document calculated in said step (e), in addition to printing said document from said start page, in said step (d).

5. The print management method as claimed in claim 1, further comprising:
(f) receiving user-specified setting concerning whether or not said substitute printing apparatus should execute printing of the same number of copies of said document as the number of copies of said document which has been assigned to said printing apparatus for printing, when a color page is included in the document, wherein
said top page of said document is determined as said start page in said step (c), and said substitute printing apparatus is designated to print said same number of copies of said document, in addition to printing said document from said start page in said step (d), when said user-specified setting states that said substitute printing apparatus should execute printing of said same number of copies of said document.

6. A computer readable recording medium stored with a print management program, said program causing a computer to execute a process comprising:
(a) recognizing an occurrence of a fault in a printing apparatus which has been designated to print a document;
(b) making a judgment as to whether or not a color page is included in said document when said occurrence of said fault in said printing apparatus is recognized;
(c) determining a start page for a substitute printing apparatus to start printing said document, which serves as a substitute for said printing apparatus, based on the judgment result of said step (b); and
(d) designating said substitute printing apparatus to print said document from said start page determined in said step (c).

7. The computer readable recording medium as claimed in claim 6, wherein
a succeeding page to the one printed by said printing apparatus immediately before said occurrence of said fault, is determined as said start page in said step (c), when it is judged that no color page is included in said document in said step (b); and
a top page of said document is determined as said start page in said step (c), when it is judged that a color page is included in said document in said step (b).

8. The computer readable recording medium as claimed in claim 7, said process further comprising:
(b1) making a judgment as to whether or not a color page is included in the pages yet to be printed by said printing apparatus, when it is judged that a color page is included in said document in said step (b), wherein
said top page is determined as said start page in said step (c), when it is judged that a color page is included in said pages yet to be printed; and
said succeeding page is determined as said start page in said step (c), when it is judged that no color page is included in said pages yet to be printed.

9. The computer readable recording medium as claimed in claim 6, said process further comprising:
(e) calculating the number of yet-to-be-printed copies of said document by subtracting the number of copies of said document which has been printed by said printing apparatus from the number of copies of said document which has been assigned to said printing apparatus for printing; wherein
said substitute printing apparatus is designated to print said number of yet-to-be-printed copies of said document calculated in said step (e), in addition to printing said document from said start page, in said step (d).

10. The computer readable recording medium as claimed in claim 6, said process further comprising:
(f) receiving user-specified setting concerning whether or not said substitute printing apparatus should execute printing of the same number of copies of said document as the number of copies of said document which has been assigned to said printing apparatus for printing, when a color page is included in the document, wherein
said top page of said document is determined as said start page in said step (c), and said substitute printing apparatus is designated to print said same number of copies of said document, in addition to printing said document from said start page in said step (d), when said user-specified setting states that said substitute printing apparatus should execute printing of said same number of copies of said document.

11. A print management apparatus, comprising:
a recognizing unit for recognizing an occurrence of a fault in a printing apparatus which has been designated to print a document;
a document judging unit for making a judgment as to whether or not a color page is included in said document when said occurrence of said fault in said printing apparatus is recognized;
a determining unit for determining a start page for a substitute printing apparatus to start printing said document, which serves as a substitute for said printing apparatus, based on the judgment result of said document judging unit; and
a designating unit for designating said substitute printing apparatus to print said document from said start page determined by said determining unit.

12. The print management apparatus as claimed in claim 11, wherein
said determining unit determines a succeeding page to the one printed by said printing apparatus immediately before said occurrence of said fault as said start page, when it is judged that no color page is included in said document by said document judging unit; and
said determining unit determines a top page of said document as said start page, when it is judged that a color page is included in said document by said document judging unit.

13. The print management apparatus as claimed in claim 12, further comprising:
a page judging unit for making a judgment as to whether or not a color page is included in the pages yet to be printed by said printing apparatus, when it is judged that a color page is included in said document by said document judging unit, wherein
said determining unit determines said top page as said start page, when it is judged that a color page is included in said pages yet to be printed; and
said determining unit determines said succeeding page as said start page, when it is judged that no color page is included in said pages yet to be printed.

14. The print management apparatus as claimed in claim 11, further comprising:
a calculating unit for calculating the number of yet-to-be-printed copies of said document by subtracting the number of copies of said document which has been printed by said printing apparatus from the number of copies of said document which has been assigned to said printing apparatus for printing; wherein
said designating unit designates said substitute printing apparatus to print said number of yet-to-be-printed copies of said document calculated by said calculating unit, in addition to printing said document from said start page.

15. The print management apparatus as claimed in claim 11, further comprising:
a receiving unit for receiving user-specified setting concerning whether or not said substitute printing apparatus should execute printing of the same number of copies of said document as the number of copies of said document which has been assigned to said printing apparatus for printing, when a color page is included in the document, wherein
said determining unit determines said top page of said document as said start page, and said designating unit designates said substitute printing apparatus to print said same number of copies of said document, in addition to printing said document from said start page, when said user-specified setting states that said substitute printing apparatus should execute printing of said same number of copies of said document.
